(19) United States
(12) Patent Application Publication
(10) Pub. No.: US 2022/0026789 A1
(43) Pub. Date: Jan. 27, 2022

(54) ILLUMINATION DEVICE AND PROJECTOR

(71) Applicant: SEIKO EPSON CORPORATION, Tokyo (JP)

(72) Inventor: Koichi AKIYAMA, Azumino-shi (JP)

(73) Assignee: SEIKO EPSON CORPORATION, Tokyo (JP)

(21) Appl. No.: 17/382,731

(22) Filed: Jul. 22, 2021

(30) Foreign Application Priority Data
Jul. 23, 2020 (JP) 2020-125891

(51) Int. Cl. G03B 21/20

(52) U.S. Cl. CPC G03B 21/204; G03B 21/2066; G03B 21/208

(57) ABSTRACT

An illumination device including light source section for emitting first light in first wavelength band, optical element having first area for transmitting or reflecting part of first light, and second area for reflecting another part of first light when it's transmitted through first area or when first light is reflected by first area, first wavelength conversion element wherein first light emitted from first area enters, converts part of first light into second light in second wavelength band while diffusing another part of first light, and then emits result, and second wavelength conversion element wherein first light emitted from second area enters, and converts first light into third light in third wavelength band different from first and second wavelength bands, wherein first and second areas reflect third light when transmitting second light, and transmit third light when reflecting second light, and second area is disposed to surround periphery of first area.

The present application is based on, and claims priority from JP Application Serial Number 2020-125891, filed Jul. 23, 2020, the disclosure of which is hereby incorporated by reference herein in its entirety.

### BACKGROUND

### 1. Technical Field

The present disclosure relates to an illumination device and a projector.

### 2. Related Art

In the past, as an illumination device, there has been a light source device having a light source for generating blue light, a first phosphor which is excited by the blue light to generate first fluorescence, a second phosphor which is excited by the blue light to generate second fluorescence different from the first fluorescence, and a spectroscopic optical element (see, e.g., JP-A-2020-052341).

However, in the illumination device described above, since a light path of the blue light is branched into two by a half mirror disposed in a central portion of the spectroscopic optical element, when, for example, the blue light large in flux width is emitted from the light source, a flux compression device for compressing the light flux of the blue light and making the result enter the half mirror becomes necessary. Therefore, there is a problem that reduction in size of the illumination device is hindered.

### SUMMARY

In view of the problems described above, according to an aspect of the present disclosure, there is provided an illumination device including a light source section configured to emit first light in a first wavelength band, an optical element having a first area configured to one of transmit and reflect a part of the first light, and a second area configured to one of reflect another part of the first light when the first light is transmitted through the first area and transmit another part of the first light when the first light is reflected by the first area, a first wavelength conversion element which the first light emitted from the first area of the optical element enters, which is configured to convert a part of the first light into second light in a second wavelength band different from the first wavelength band while diffusing another part of the first light, and then emit a result, and a second wavelength conversion element which the first light emitted from the second area of the optical element enters, and which is configured to convert the first light into third light in a third wavelength band different from the first wavelength band and the second wavelength band, wherein the first area and the second area reflect the third light when transmitting the second light, and transmit the third light when reflecting the second light, and the second area is disposed so as to surround a periphery of the first area.

According to a second aspect of the present disclosure, there is provided a projector including the illumination device according to the first aspect of the present disclosure, a light modulation device configured to modulate light from the illumination device in accordance with image information, and a projection optical device configured to project the light modulated by the light modulation device .

### BRIEF DESCRIPTION OF THE DRAWINGS

FIG. 1 is a schematic configuration diagram of a projector according to a first embodiment.

FIG. 2 is a schematic configuration diagram of an illumination device according to the first embodiment.

FIG. 3 is a diagram conceptually showing light emitted from an optical element.

FIG. 4 is a diagram conceptually showing illumination light emitted from an optical element in a comparative example.

FIG. 5 is a schematic configuration diagram of an illumination device according to a second embodiment.

FIG. 6 is a schematic configuration diagram of an illumination device according to a third embodiment.

FIG. 7 is a schematic configuration diagram of an illumination device according to a fourth embodiment.

FIG. 8A is a configuration diagram of a principal part of a first wavelength conversion element in a first modified example.

FIG. 8B is a configuration diagram of a principal part of the first wavelength conversion element in the first modified example.

FIG. 8C is a configuration diagram of a principal part of the first wavelength conversion element in the first modified example.

FIG. 9 is a configuration diagram of a principal part of a wavelength conversion element in a second modified example.

### DESCRIPTION OF EXEMPLARY EMBODIMENTS

### First Embodiment

A first embodiment of the present disclosure will hereinafter be described using the drawings.

In the drawings described below, the constituents are shown with respective scale ratios of the sizes different from each other in some cases in order to make the constituents eye-friendly.

An example of a projector according to the present embodiment will be described.

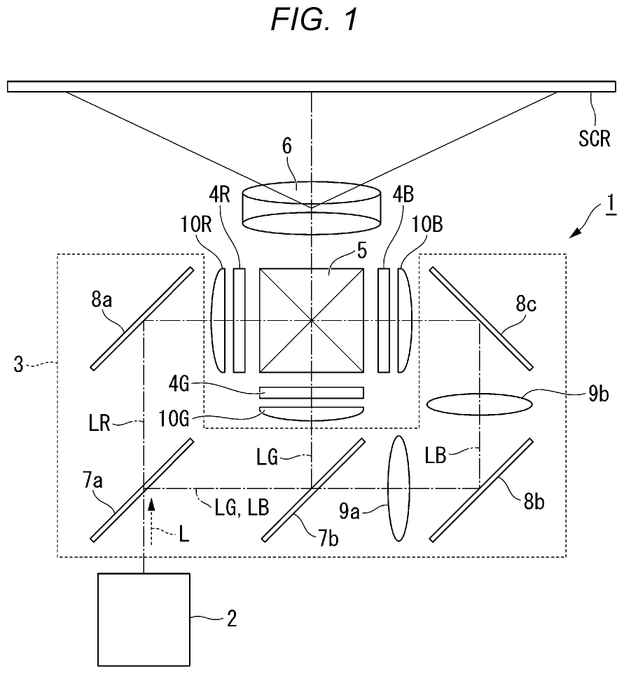

FIG. 1 is a schematic configuration diagram of the projector according to the present embodiment.

As shown in FIG. 1, the projector 1 according to the present embodiment is a projection-type image display device for displaying a color image on a screen SCR. The projector 1 is provided with an illumination device 2, a color separation optical system 3, a light modulation device 4R, a light modulation device 4G, a light modulation device 4B, a combining optical system 5, and a projection optical device 6. A configuration of the illumination device 2 will be described later.

The color separation optical system 3 is provided with a first dichroic mirror 7a, a second dichroic mirror 7b, a reflecting mirror 8a, a reflecting mirror 8b, a reflecting mirror 8c, a relay lens 9a, and a relay lens 9b. The color separation optical system 3 separates illumination light L emitted from the illumination device 2 into red light LR, green light LG, and blue light LB, and then guides the red light LR to the light modulation device 4R, guides the green light LG to the light modulation device 4G, and guides the blue light LB to the light modulation device 4B.

A field lens 10R is disposed between the color separation optical system 3 and the light modulation device 4R, and substantially collimates the incident light and then emits the result toward the light modulation device 4R. A field lens 10G is disposed between the color separation optical system 3 and the light modulation device 4G, and substantially collimates the incident light and then emits the result toward the light modulation device 4G. A field lens 10B is disposed between the color separation optical system 3 and the light modulation device 4B, and substantially collimates the incident light and then emits the result toward the light modulation device 4B.

The first dichroic mirror 7a transmits a red light component, and reflects a green light component and a blue light component. The second dichroic mirror 7b reflects the green light component, and transmits the blue light component. The reflecting mirror 8a reflects the red light component. The reflecting mirror 8b and the reflecting mirror 8c reflect the blue light component.

The red light LR having been transmitted through the first dichroic mirror 7a is reflected by the reflecting mirror 8a, and is then transmitted through the field lens 10R to enter an image formation area of the light modulation device 4R for the red light. The green light LG having been reflected by the first dichroic mirror 7a is further reflected by the second dichroic mirror 7b, and then transmitted through the field lens 10G to enter an image formation area of the light modulation device 4G for the green light. The blue light LB having been transmitted through the second dichroic mirror 7b enters an image formation area of the light modulation device 4B for the blue light via the relay lens 9a, the reflecting mirror 8b at the incident side, the relay lens 9b, the reflecting mirror 8c at the exit side, and the field lens 10B.

The light modulation device 4R, the light modulation device 4G, and the light modulation device 4B each modulate the colored light having entered the light modulation device in accordance with image information to thereby form image light. The light modulation device 4R, the light modulation device 4G, and the light modulation device 4B are each formed of a liquid crystal light valve. Although not shown in the drawings, at the light incident side of each of the light modulation device 4R, the light modulation device 4G, and the light modulation device 4B, there is disposed an incident side polarization plate. At the light exit side of each of the light modulation device 4R, the light modulation device 4G, and the light modulation device 4B, there is disposed an exit side polarization plate.

The combining optical system 5 combines the image light emitted from the light modulation device 4R, the image light emitted from the light modulation device 4G, and the image light emitted from the light modulation device 4B with each other to form full-color image light. The combining optical system 5 is formed of a cross dichroic prism having four rectangular prisms bonded to each other to have a substantially square shape in the plan view. On the interfaces having a substantially X shape on which the rectangular prisms are bonded to each other, there are formed dielectric multilayer films.

The image light emitted from the combining optical system 5 is projected by the projection optical device 6 in an enlarged manner to form an image on the screen SCR. In other words, the projection optical device 6 projects the light modulated by the light modulation device 4R, the light modulated by the light modulation device 4G, and the light modulated by the light modulation device 4B. The projection optical device 6 is constituted by a plurality of projection lenses.

An example of the illumination device 2 according to the present embodiment will be described.

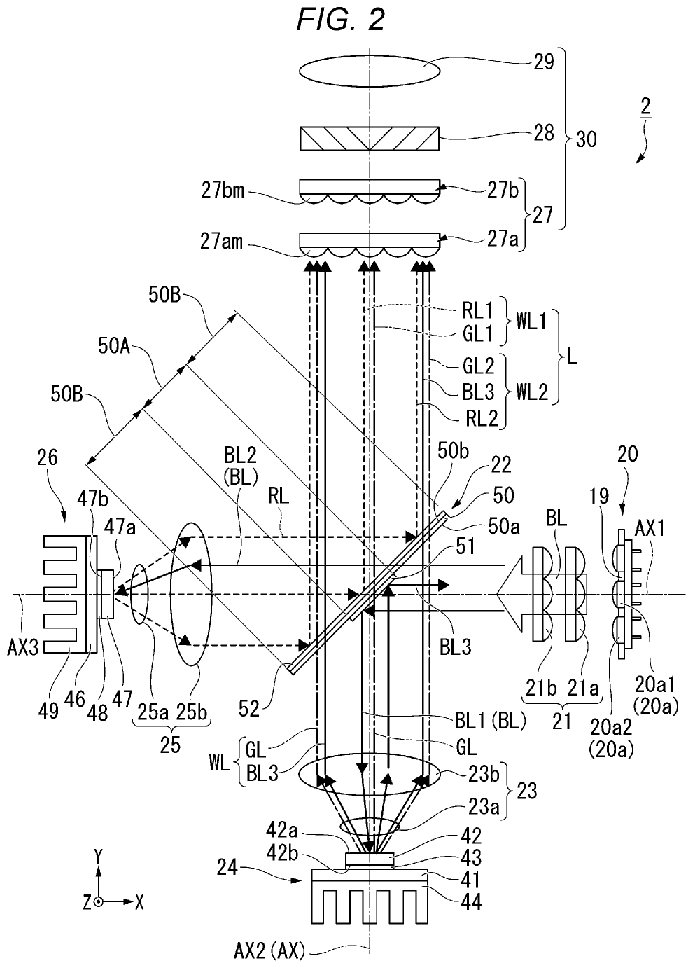

FIG. 2 is a schematic configuration diagram of the illumination device 2.

As shown in FIG. 2, the illumination device 2 according to the present embodiment is provided with a blue array light source (a light source section) 20, a homogenizer optical system 21, an optical element 22, a first pickup optical system 23, a first wavelength conversion element 24, a second pickup optical system 25, a second wavelength conversion element 26, and a homogenization illumination optical system 30.

Hereinafter, using an XYZ orthogonal coordinate system, an axis parallel to a principal ray of blue light BL emitted from the blue array light source 20 and a principal ray of fluorescence RL emitted from the second wavelength conversion element 26 is defined as an X axis, an axis parallel to a principal ray of fluorescence GL emitted from the first wavelength conversion element 24 is defined as a Y axis, and an axis perpendicular to the X axis and the Y axis is defined as a Z axis.

Further, an axis extending along the principal ray of the blue light BL is referred to as an optical axis AX1 of the blue array light source 20. Therefore, the optical axis AX1 of the blue array light source 20 is parallel to the X axis. An axis extending along the principal ray of the fluorescence GL is referred to as an optical axis AX2 of the first wavelength conversion element 24. Therefore, the optical axis AX2 of the first wavelength conversion element 24 is parallel to the Y axis. In the present embodiment, the optical axis AX2 coincides with an illumination optical axis AX of the illumination device 2. An axis extending along the principal ray of the fluorescence RL is referred to as an optical axis AX3 of the second wavelength conversion element 26. In the present embodiment, the optical axis AX3 coincides with the optical axis AX1 of the blue array light source 20.

In the present embodiment, the blue array light source 20, the homogenizer optical system 21, the optical element 22, the second pickup optical system 25, and the second wavelength conversion element 26 are disposed on the optical axis AX1. The first wavelength conversion element 24, the first pickup optical system 23, the optical element 22, and the homogenization illumination optical system 30 are disposed on the illumination optical axis AX.

The blue array light source 20 is provided with a plurality of light emitting elements 20a. The blue array light source 20 in the present embodiment is provided with, for example, seven light emitting elements 20a. The seven light emitting elements 20a include a single first light emitting 20a1 located on the optical axis AX1 of the blue light LB, and six second light emitting elements 20a2 disposed so as to surround the periphery of the first light emitting element 20a1. As described above, the six second light emitting elements 20a2 located on the periphery are disposed around the optical axis AX1 of the blue light LB so as to substantially be rotationally symmetric. The seven light emitting elements 20a are supported by a support member 19.

The light emitting elements 20a are each formed of a CAN-package type semiconductor laser element. The semiconductor laser element emits a blue light beam in a first wavelength band having a peak wavelength in a range of, for example, 440 nm through 470 nm. Each of the light emitting elements 20a substantially collimates the blue light beam with a collimating lens disposed in a light exit.

Due to the configuration described above, each of the light emitting elements 20a emits the blue light beam thus collimated. The blue array light source 20 emits the blue light (first light) LB formed of the seven blue light beams. The principal rays of the respective blue light beams are parallel to each other. The blue light beam emitted from each of the light emitting elements 20a is linearly-polarized light. Therefore, the blue light LB emitted from the blue array light source 20 is linearly-polarized light.

The blue light BL emitted from the blue array light source 20 enters the homogenizer optical system 21. It should be noted that an afocal optical system is disposed between the blue array light source 20 and the homogenizer optical system 21 to reduce the flux diameter of the blue light BL as needed. By reducing the flux diameter of the blue light BL with the afocal optical system, it is possible to reduce the size of the homogenizer optical system 21.

The homogenizer optical system 21 converts the illuminance distribution of the pencil into a uniform distribution, namely a so-called top-hat distribution, in an illumination target area. The homogenizer optical system 21 is constituted by a first multi-lens array 21a and a second multi-lens array 21b.

The blue light BL having passed through the homogenizer optical system 21 enters the optical element 22.

The optical element 22 is disposed so as to form an angle of 45° with each of the optical axis AX1 and the optical axis AX3, and the illumination optical axis AX and the optical axis AX2.

The optical element 22 in the present embodiment includes a first area 50A and a second area 50B.

In the present embodiment, the size of the optical element 22 is set so that the whole of the light flux of the blue light BL can enter the entire area of a transparent substrate 50. Therefore, the blue light BL having been emitted from the blue array light source 20 enters each of the first area 50A and the second area 50B.

The optical element 22 has the transparent substrate 50, a first dichroic mirror 51, and a second dichroic mirror 52. In the present embodiment, the first dichroic mirror 51 is disposed on a first surface 50a of the transparent substrate 50, and the second dichroic mirror 52 is disposed on a second surface 50b of the transparent substrate 50 different from the first surface 50a. In other words, in the optical element 22 in the present embodiment, the first dichroic mirror 51 and the second dichroic mirror 52 are disposed on the both surfaces of the transparent substrate 50, respectively.

In the present embodiment, planar shapes of the first dichroic mirror 51 and the second dichroic mirror 52 are each a substantially circular shape. The planar shape of the first dichroic mirror 51 is smaller than the planar shape of the second dichroic mirror 52.

In the optical element 22 in the present embodiment, the first area 50A is disposed so as to correspond to at least an area in which the first dichroic mirror 51 is formed out of the transparent substrate 50.

The second area 50B is disposed so as to correspond to an area in which only the second dichroic mirror 52 is formed out of the transparent substrate 50. The second area 50B corresponds to an area which does not have a planar overlap with the first dichroic mirror 51 out of the second dichroic mirror 52. In the optical element 22 in the present embodiment, the first area 50A is disposed at the center of the optical element 22, and the second area 50B is disposed so as to surround the periphery of the first area 50A.

The first area 50A is disposed at the center of the optical element 22 where the illumination optical axis AX and the optical axis AX2, and the optical axis AX1 and the optical axis AX3 cross each other. The second area 50B is disposed in a peripheral part of the optical element 22 so as to surround the periphery of the first area 50A. In the present embodiment, the area of the first area 50A is sufficiently smaller than the area of the second area 50B. For example, the area of the first area 50A is smaller than a half of the area of the second area 50B. It should be noted that in the illumination device 2 according to the present embodiment, the intensity of the light to be emitted from the first area 50A is set so as to be higher than the intensity of the light to be emitted from the second area 50B.

In the optical element 22 in the present embodiment, a central component as a part of the light flux of the blue light BL enters the first area 50A, and a peripheral component except the central component, namely the rest of the light flux of the blue light BL, enters the second area 50B.

Hereinafter, the central component of the blue light BL which enters the first area 50A of the optical element 22 is referred to as first blue light BL1, and the peripheral component of the blue light BL which enters the second area 50B of the optical element 22 is referred to as second blue light BL2.

The first dichroic mirror 51 has a characteristic of reflecting light in the blue wavelength band while transmitting light in the green wavelength band. Therefore, the first blue light BL1 is reflected by the first dichroic mirror 51.

In contrast, the second dichroic mirror 52 has a characteristic of reflecting light in the red wavelength band while transmitting the light in the green wavelength band and the light in the blue wavelength band. Therefore, the second blue light BL2 is transmitted through the second dichroic mirror 52.

As described hereinabove, the optical element 22 in the present embodiment reflects the first blue light BL1 which has entered the first area 50A toward the first wavelength conversion element 24, and at the same time, transmits the second blue light BL2 which has entered the second area 50B toward the second wavelength conversion element 26. In other words, the optical element 22 in the present embodiment is capable of separating the blue light BL emitted from the blue array light source 20 into the first blue light BL1 and the second blue light BL2, and making the first blue light BL1 and the second blue light BL2 respectively enter the first wavelength conversion element 24 and the second wavelength conversion element 26 in a sorted manner.

In the optical element 22 in the present embodiment, since the first dichroic mirror 51 and the second dichroic mirror 52 each having the circular shape are formed on the both surfaces of the transparent substrate 50, the second dichroic mirror 52 is not required to be formed to have a ring-like shape, and therefore, it becomes easy to manufacture each of the dichroic mirrors.

It should be noted that the configuration of the optical element 22 is not limited to the above, and it is possible to form the first dichroic mirror 51 and the second dichroic mirror 52 on, for example, the same surface (e.g., the first surface 50a) of the transparent substrate 50. In this case, it is sufficient to form the first dichroic mirror 51 and the second dichroic mirror 52 having a ring-like shape surrounding the periphery of the first dichroic mirror 51 using, for example, a mask. In this case, as the first dichroic mirror 51, there is used a mirror having a characteristic of reflecting the light in the red wavelength band in addition to the light in the blue wavelength band, and transmitting the light in the green wavelength band.

The first blue light BL1 reflected by the first area 50A of the optical element 22 enters the first pickup optical system 23. The first pickup optical system 23 is disposed between the optical element 22 and the first wavelength conversion element 24. The first pickup optical system 23 is constituted by two convex lenses formed of a first lens 23a and a second lens 23b. It should be noted that the number of the lenses constituting the first pickup optical system 23 is not particularly limited. The first pickup optical system 23 collects the first blue light BL1 to enter the first wavelength conversion element 24.

The first wavelength conversion element 24 is provided with a first base member 41, a first wavelength conversion layer 42, a first reflecting layer 43, and a first heatsink 44. In the present embodiment, the first wavelength conversion layer 42 is formed of a phosphor. As the first wavelength conversion element 24 in the present embodiment, there is used a reflective type wavelength conversion element which is not made rotatable due to a motor or the like.

The first wavelength conversion layer 42 has a first surface 42a which the first blue light BL1 enters, and a second surface 42b different from the first surface 42a. The first wavelength conversion layer 42 is held by the first base member 41 via a bonding material (not shown). As the bonding material, there is used, for example, a nano-silver sintered metal material.

The first wavelength conversion element 42 performs the wavelength conversion of the first blue light BL1 into the fluorescence (second light) GL in a second wavelength band different from the first wavelength band. The first wavelength conversion layer 42 includes a green phosphor which is excited by the first blue light BL1 in the blue wavelength band to emit the light in the green wavelength band. Specifically, the first wavelength conversion layer 42 includes a phosphor material such as a Lu₃Al₅O₁₂:Ce³⁺ phosphor, a Y₃O₄:Eu²⁺ phosphor, a (Ba,Sr)₂SiO₄:Eu²⁺ phosphor, a Ba₃Si₆O₁₂N₂:Eu²⁺ phosphor, or a (Si,Al)₆(O,N)₈:Eu²⁺ phosphor. The fluorescence GL is green light having a peak wavelength in a range of, for example, 500 through 570 nm.

The phosphor constituting the first wavelength conversion layer 42 in the present embodiment includes a scattering element for scattering the light inside. As the scattering element, there is used, for example, a plurality of air holes. Due to the configuration described above, apart of the first blue light BL1 having entered the first wavelength conversion element 24 is converted in wavelength by the first wavelength conversion layer 42 into the fluorescence GL. Meanwhile, another part of the first blue light BL1 is scattered by the scattering element before converted in wavelength into the fluorescence GL, and then emitted outside the first wavelength conversion element 24 without being converted in wavelength. On this occasion, the first blue light BL1 is emitted from the first wavelength conversion element 24 as diffused blue light BL3 in a state of being diffused into an angular distribution substantially the same as the angular distribution of the fluorescence GL.

The first reflecting layer 43 is disposed on the second surface 42b of the first wavelength conversion layer 42. The first reflecting layer 43 is disposed between the first base member 41 and the first wavelength conversion layer 42. The first blue light BL1 and the fluorescence GL entering the first reflecting layer 43 from the first wavelength conversion layer 42 are reflected by the first reflecting layer 43 toward the first pickup optical system 23. The first reflecting layer 43 is formed of a laminated film including, for example, a dielectric multilayer film, a metal mirror, and a reflection enhancing film. Further, the first reflecting layer 43 can be formed of a multilayer film including, for example, a dielectric multilayer film, a metal mirror, and a reflection enhancing film.

The first heatsink 44 has a plurality of fins. The first heatsink 44 is disposed so as to be opposed to the first wavelength conversion layer 42 across the first base member 41. The first heatsink 44 is fixed to the first base member 41 with, for example, metal bonding. In the first wavelength conversion element 24, since the heat release can be achieved via the first heatsink 44, it is possible to prevent the heat deterioration of the first wavelength conversion layer 42.

As described hereinabove, the first wavelength conversion element 24 in the present embodiment converts apart of the first blue light BL1 into the fluorescence GL as the green light, and diffuses another part of the first blue light BL1 to emit the result as the diffused blue light BL3. In other words, the first wavelength conversion element 24 emits light WL including the diffused blue light BL3 and the fluorescence GL toward the first pickup optical system 23. The light WL emitted from the first wavelength conversion element 24 is collimated by the first pickup optical system 23, and then enters the optical element 22. The light WL collimated by the first pickup optical system 23 enters the entire area in the optical element 22.

Specifically, a central component of the light WL enters the first area 50A provided with the first dichroic mirror 51 out of the first surface 50a of the transparent substrate 50.

The first dichroic mirror 51 provided to the first area 50A has a characteristic of reflecting the light in the blue wavelength band while transmitting the light in the green wavelength band as described above.

The fluorescence GL included in the light WL emitted from the first wavelength conversion element 24 is the green light, and is therefore transmitted through the first dichroic mirror 51 provided to the first area 50A.

Meanwhile, the diffused blue light BL3 included in the light WL is reflected toward the blue array light source 20 by the first dichroic mirror 51. In this case, in the present embodiment, by making the area of the first area 50A sufficiently smaller than the area of the second area 50B as described above, it is possible to reduce the diffused blue light BL3 which is reflected by the first dichroic mirror 51 to return toward the blue array light source 20, and thus, becomes a loss.

Further, a peripheral part of the light WL enters a portion not provided with the first dichroic mirror 51 out of the first surface 50a of the transparent substrate 50. The peripheral part of the light WL is transmitted through the transparent substrate 50 to enter the second dichroic mirror 52 provided to the second area 50B. As described above, the second dichroic mirror 52 has a characteristic of transmitting the light in the green wavelength band and the light in the blue wavelength band. Therefore, the fluorescence GL and the diffused blue light BL3 included in the light WL are transmitted through the optical element 22.

Therefore, the first area 50A emits a part of the fluorescence GL out of the light WL emitted from the first wavelength conversion element 24, and the second area 50B emits the fluorescence GL and the diffused blue light BL3 out of the light WL emitted from the first wavelength conversion element 24.

Meanwhile, the second blue light BL2 transmitted through the second area 50B of the optical element 22 enters the second pickup optical system 25. The second pickup optical system 25 is disposed between the optical element 22 and the second wavelength conversion element 26. The second pickup optical system 25 is constituted by two convex lenses formed of a first lens 25a and a second lens 25b. It should be noted that the number of the lenses constituting the second pickup optical system 25 is not particularly limited. The second pickup optical system 25 collects the second blue light BL2 to enter the second wavelength conversion element 26.

The second wavelength conversion element 26 is provided with a second base member 46, a second wavelength conversion layer 47, a second reflecting layer 48, and a second heatsink 49. In the present embodiment, the second wavelength conversion layer 47 is formed of a phosphor. As the second wavelength conversion element 26 in the present embodiment, there is used a reflective type wavelength conversion element which is not made rotatable due to a motor or the like.

The second wavelength conversion layer 47 has a first surface 47a which the second blue light BL2 enters, and a second surface 47b different from the first surface 47a. The second wavelength conversion layer 47 is held by the second base member 46 via a bonding material (not shown). As the bonding material, there is used, for example, a nano-silver sintered metal material.

The second wavelength conversion element 47 performs the wavelength conversion of the second blue light BL2 into the fluorescence (third light) RL in a third wavelength band different from the first wavelength band and the second wavelength band. The second wavelength conversion layer 47 includes a red phosphor which is excited by the second blue light BL2 in the blue wavelength band to emit the light in the red wavelength band. Specifically, the second wavelength conversion layer 47 includes, for example, the YAG phosphor (any one of Pr:YAG, Eu:YAG, and Cr:YAG) made of (Y₁₋ₓ,Gdₓ)₃(Al,Ga)₅O₁₂ having anyone of Pr, Eu, and Cr dispersed as an activator agent. It should be noted that it is possible for the activator agent to include a species selected from Pr, Eu, and Cr, or to be a coactivation type activator agent including two or more species selected from Pr, Eu, and Cr. The fluorescence RL is red light having a peak wavelength in a range of, for example, 600 through 800 nm.

The phosphor constituting the second wavelength conversion layer 47 in the present embodiment hardly includes the scattering element unlike the green phosphor constituting the first wavelength conversion layer 42. Further, it is possible for the second wavelength conversion element 26 to perform the wavelength conversion of the whole of the second blue light BL2 having entered the second wavelength conversion layer 47 by, for example, appropriately setting the thickness of the second wavelength conversion layer 47.

Due to the configuration described above, the whole of the second blue light BL2 having entered the second wavelength conversion element 26 is converted in wavelength by the second wavelength conversion layer 47 into the fluorescence RL.

The second reflecting layer 48 is disposed on the second surface 47b of the second wavelength conversion layer 47. The second reflecting layer 48 is disposed between the second base member 46 and the second wavelength conversion layer 47. The fluorescence RL entering the second reflecting layer 48 from the second wavelength conversion layer 47 is reflected by the second reflecting layer 48 toward the second pickup optical system 25. The second reflecting layer 48 is formed of a laminated film including, for example, a dielectric multilayer film, a metal mirror, and a reflection enhancing film. Further, the second reflecting layer 48 can be formed of a multilayer film including, for example, a dielectric multilayer film, a metal mirror, and a reflection enhancing film.

The second heatsink 49 has a plurality of fins. The second heatsink 49 is disposed so as to be opposed to the second wavelength conversion layer 47 across the second base member 46. The second heatsink 49 is fixed to the second base member 46 with, for example, metal bonding. In the second wavelength conversion element 26, since the heat release can be achieved via the second heatsink 49, it is possible to prevent the heat deterioration of the second wavelength conversion layer 47.

As described hereinabove, the second wavelength conversion element 26 in the present embodiment converts the whole of the second blue light BL2 into the fluorescence RL as the red light, and then emits the fluorescence RL. In other words, the second wavelength conversion element 26 emits the fluorescence RL toward the second pickup optical system 25. The fluorescence RL emitted from the second wavelength conversion element 26 is collimated by the second pickup optical system 25, and then enters the optical element 22.

In the present embodiment, the fluorescence RL which is emitted from the second wavelength conversion element 26 and is then collimated by the second pickup optical system 25 enters the entire area of the optical element 22. The fluorescence RL enters the first area 50A and the second area 50B. Specifically, the fluorescence RL enters the second dichroic mirror 52 provided to the second surface 50b of the transparent substrate 50.

As described above, the second dichroic mirror 52 has a characteristic of reflecting the light in the red wavelength band. Since the fluorescence RL emitted from the second wavelength conversion element 26 is the red light, the optical element 22 reflects the fluorescence RL. The second dichroic mirror 52 is disposed in both of the first area 50A and the second area 50B. The first area 50A and the second area 50B emit the fluorescence RL emitted from the second wavelength conversion element 26. Therefore, in the optical element 22 in the present embodiment, the first area 50A and the second area 50B transmit the fluorescence GL, and reflect the fluorescence RL.

As shown in FIG. 2, the first area 50A emits the fluorescence GL out of the light WL emitted from the first wavelength conversion element 24, and the second area 50B emits the fluorescence GL and the diffused blue light BL3 out of the light WL emitted from the first wavelength conversion element 24. Further, the first area 50A and the second area 50B emit the fluorescence RL emitted from the second wavelength conversion element 26. Hereinafter, out of the fluorescence GL, a component emitted from the first area 50A is referred to as fluorescence GL1, and a component emitted from the second area 50B is referred to as fluorescence GL2.

According to the optical element 22 in the present embodiment, yellow illumination light (first illumination light) WL1 including the fluorescence GL1 and the fluorescence RL is emitted from the first area 50A toward the homogenization illumination optical system 30, and white illumination light (second illumination light) WL2 including the fluorescence GL2, the fluorescence RL, and the diffused blue light BL3 is emitted from the second area 50B toward the homogenization illumination optical system 30. Hereinafter, the yellow illumination light WL1 and the white illumination light WL2 are collectively referred to simply as the illumination light L.

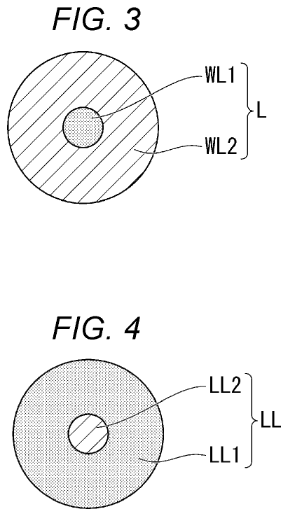

FIG. 3 is a diagram conceptually showing light emitted from the first area 50A and the second area 50B of the optical element 22. It should be noted that FIG. 3 is a diagram of the optical device 22 viewed from the illumination optical axis AX side.

As shown in FIG. 3, the illumination device 2 according to the present embodiment generates light in which the yellow illumination light WL1 is located at the center of the light flux, and the white illumination light WL2 is located on the periphery of the yellow illumination light WL1 as the illumination light L. The yellow illumination light WL1 is emitted from the first area 50A, and the white illumination light WL2 is emitted from the second area 50B.

The illumination light L having been emitted from the optical element 22 enters the homogenization illumination optical system 30. The homogenization illumination optical system 30 includes an integrator optical system 27, a polarization conversion element 28, and a superimposing lens 29.

The integrator optical system 27 has a first multi-lens array 27a, and a second multi-lens array 27b. The first multi-lens array 27a has a plurality of first lenses 27am for dividing the illumination light L into a plurality of partial light beams.

A lens surface of the first multi-lens array 27a, namely surfaces of the first lenses 27am, and the image formation area of each of the light modulation devices 4R, 4G, and 4B are conjugated with each other. Therefore, the shape of each of the first lenses 27am is a rectangular shape as a substantially similar shape to the shape of the image formation area of each of the light modulation devices 4R, 4G, and 4B when viewed from the direction of the optical axis AX2. Thus, each of the partial light beams emitted from the first multi-lens array 27a efficiently enters the image formation area of each of the light modulation devices 4R, 4G, and 4B.

The second multi-lens array 27b has a plurality of second lenses 27bm corresponding respectively to the first lenses 27am of the first multi-lens array 27a. The second multi-lens array 27b forms an image of each of the first lenses 27am of the first multi-lens array 27a in the vicinity of the image formation area of each of the light modulation devices 4R, 4G, and 4B in cooperation with the superimposing lens 29.

The illumination light L having been transmitted through the integrator optical system 27 enters the polarization conversion element 28. The polarization conversion element 28 has a configuration in which polarization split films and wave plates not shown are arranged in an array. The polarization conversion element 28 uniforms the polarization direction of the illumination light L into a predetermined direction. Specifically, the polarization conversion element 28 uniforms the polarization direction of the illumination light L into a direction of a transmission axis of the incident side polarization plate of each of the light modulation devices 4R, 4G, and 4B.

Thus, the polarization direction of the red light LR, the green light LG, and the blue light LB separated from the illumination light L having been transmitted through the polarization conversion element 28 coincides with the transmission axis direction of the incident side polarization plate of each of the light modulation devices 4R, 4G, and 4B. Therefore, the red light LR, the green light LG, and the blue light LB enter the image formation areas of the light modulation devices 4R, 4G, and 4B, respectively, without being blocked by the incident side polarization plates, respectively.

The illumination light L having been transmitted through the polarization conversion element 28 enters the superimposing lens 29. The superimposing lens 29 homogenizes the illuminance distribution in the image formation area of each of the light modulation devices 4R, 4G, and 4B as an illumination target area in cooperation with the integrator optical system 27.

Here, effectiveness of the illumination light L generated by the illumination device 2 according to the present embodiment will be described with reference to a comparative example. As the comparative example, there will hereinafter be considered when a light beam in which the white illumination light is located at the center of the flux, and the yellow illumination light surrounds the periphery of the white illumination light to form a ring-like shape is generated as the illumination light to be emitted from the optical element. In other words, as the comparative example, there is adopted a configuration in which the second blue light BL2 as the peripheral component of the blue light BL is configured to diffusely be reflected at the second wavelength conversion element 26 side, and the whole of the first blue light BL1 as the central component of the blue light is used for the excitation of the first wavelength conversion element 24.

FIG. 4 is a diagram conceptually showing the illumination light emitted from the optical element in the comparative example. As shown in FIG. 4, in illumination light LL in the comparative example, a central part of the light flux is formed of white illumination light LL2, and a peripheral part of the light flux is formed of yellow illumination light LL1. In the illumination light LL, the light of the green component and the red component exists in the white illumination light LL2 in the central part of the light flux and the yellow illumination light LL1 in the peripheral part of the light flux. In other words, the light of the green component and the red component is included in the entire flux of the illumination light LL. In contrast, the light of the blue component exists only in the white illumination light LL2, namely the central part of the light flux.

As described hereinabove, in the configuration of the comparative example, the light of the blue component exists only in the center of the flux of the illumination light LL, and the light of the green component and the light in the red component exist in the entire flux of the illumination light LL. On this occasion, an incident angle distribution when the light of the blue component enters the light modulation device 4B via the homogenization illumination optical system 30 becomes significantly different from an incident angle distribution when the light of the green component or the light of the red component enters the light modulation devices 4G, 4R.

In other words, when the illumination light LL in the comparative example is used, there is created the state in which an F-number of an illumination system which makes the blue light LB enter the light modulation device 4B is significantly different from an F-number of an illumination system which makes the green light LG enter the light modulation device 4G, or an F-number of an illumination system which makes the red light LR enter the light modulation device 4R. When the F-numbers of the illumination systems for making the light enter the respective light modulation devices 4B, 4G, and 4R are significantly different from each other as described above, there occurs a difference in illuminance distribution between the light modulation devices 4B, 4G, and 4R, and as a result, a color variation occurs in the display image.

In contrast, according to the illumination device 2 related to the present embodiment, since there is generated the illumination light L in which the yellow illumination light WL1 is located in the central part of the light flux, and the white illumination light WL2 is located in the peripheral part of the light flux, it is possible to generate the illumination light L in which the light of the blue component exists in an area except the center of the flux, and the light of the green component and the light of the red component exist in the entire flux unlike the illumination light LL in the comparative example. Thus, a difference caused between the incident angle distribution when the blue light LB separated from the illumination light L enters the light modulation device 4B and the incident angle distribution when the green light LG and the red light LR respectively enter the light modulation devices 4G, 4R can be made smaller compared to when using the illumination light LL in the comparative example.

Therefore, according to the projector 1 using the illumination device 2 related to the present embodiment, by suppressing the difference caused between the illuminance distributions of the respective light modulation devices 4B, 4G, and 4R, it is possible to reduce the occurrence of the color variation in the display image.

### Advantages of First Embodiment

The illumination device 2 according to the present embodiment is provided with the blue array light source 20 for emitting the blue light BL, the optical element 22 having the first area 50A for reflecting a part of the blue light BL and the second area 50B for transmitting another part of the blue light BL, a first wavelength conversion element 24 which the blue light BL emitted from the first area 50A of the optical element 22 enters, and which converts a part of the blue light BL into the fluorescence GL having a green color, and diffuses another part of the blue light BL to emit the result, and a second wavelength conversion element 26 which the blue light BL emitted from the second area 50B of the optical element enters, and which converts the blue light BL into the fluorescence RL having a red color, wherein the first area 50A and the second area 50B transmit the fluorescence GL and reflect the fluorescence RL, the first area 50A is disposed at the center of the optical element 22, and the second area 50B is disposed so as to surround the periphery of the first area 50A.

According to the illumination device 2 having the configuration described above, it is possible to separate the central component as a part of the blue light BL emitted from the blue array light source 20 with the first area 50A of the optical element 22 to enter the first wavelength conversion element 24, and to separate the peripheral component as another part of the blue light BL with the second area 50B to enter the second wavelength conversion element 26. In other words, it is possible to separate the blue light BL entering the entire area of the optical element 22 into two parts. Therefore, since it is not necessary to compress the flux width of the blue light BL to make the blue light BL enter the optical element 22 as when separating the excitation light using the half mirror in the related art, a flux compression device for compressing the flux width of the blue light BL becomes unnecessary. When supposedly using the flux compressing device, since it is not necessary to significantly compress the blue light BL, one low in flux compression ratio, namely a small-sized flux compression device, is used as the flux compression device. Therefore, according to the illumination device 2 related to the present embodiment, since the flux compression device is unnecessary, or it is possible to use a small-sized flux compression device, it is possible to reduce the size of the device configuration of the illumination device 2 as a result.

In the illumination device 2 according to the present embodiment, there may further be included the homogenization illumination optical system 30 for homogenizing the illuminance distribution of the illumination light L emitted from the optical element 22, wherein the first area 50A of the optical element 22 emits the yellow illumination light WL1 toward the homogenization illumination optical system, the second area 50B of the optical element 22 has a configuration of emitting the white illumination light WL2 toward the homogenization illumination optical system 30.

According to this configuration, it is possible to generate the illumination light L in which the light of the blue component exists in an area except the center of the light flux, and the light of the green component and the light of the red component exist in the entire light flux. Thus, the difference caused between the incident angle distribution when the blue light LB separated from the illumination light L enters the light modulation device 4B and the incident angle distribution when the green light LG and the red light LR respectively enter the light modulation devices 4G, 4R can be made smaller.

The projector 1 according to the present embodiment is provided with the illumination device 2, the light modulation devices 4R, 4G, and 4B for modulating light from the illumination device 2 in accordance with image information, and the projection optical device 6 for projecting the light modulated by the light modulation device 4R, 4G, and 4B.

According to the projector 1 related to the present embodiment, since the illumination device 2 small in size is provided, it is possible to realize the reduction in size of the projector itself. Further, since the difference caused between the illuminance distributions of the respective light modulation devices 4B, 4G, and 4R can be suppressed, it is possible to provide the projector for displaying a high quality image in which generation of the color variation in display image is reduced.

### Second Embodiment

A second embodiment of the present disclosure will hereinafter be described using the drawings.

A projector according to the second embodiment is substantially the same in configuration as that of the first embodiment, but is different in configuration of a part of the illumination device from that of the first embodiment. Therefore, the description of the overall configuration of the projector and a common configuration of the illumination device will be omitted. It should be noted that members and constituents common to the first embodiment will be denoted by the same reference symbols.

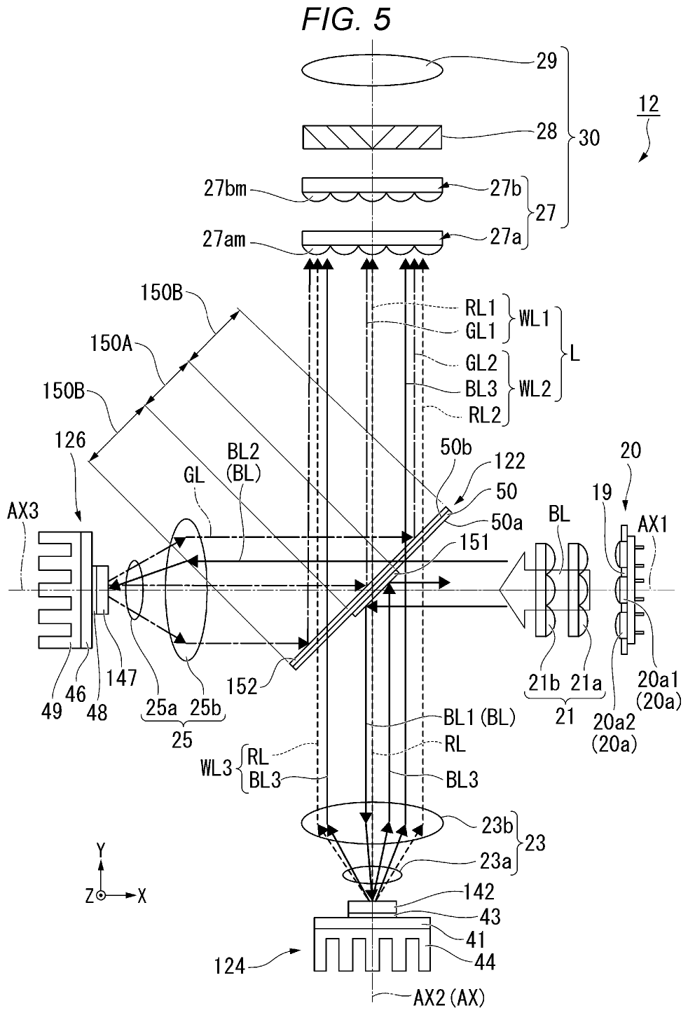

FIG. 5 is a schematic configuration diagram of an illumination device according to the second embodiment.

As shown in FIG. 5, the illumination device 12 according to the present embodiment is provided with the blue array light source 20, the homogenizer optical system 21, an optical element 122, the first pickup optical system 23, a first wavelength conversion element 124, the second pickup optical system 25, a second wavelength conversion element 126, and the homogenization illumination optical system 30.

In the present embodiment, the blue array light source 20, the homogenizer optical system 21, the optical element 122, the second pickup optical system 25, and the second wavelength conversion element 126 are disposed on the optical axis AX1. The first wavelength conversion element 124, the first pickup optical system 23, the optical element 122, and the homogenization illumination optical system 30 are disposed on the illumination optical axis AX.

The optical element 122 in the present embodiment has the transparent substrate 50, a first dichroic mirror 151, and a second dichroic mirror 152. In the optical element 122 in the present embodiment, the first dichroic mirror 151 and the second dichroic mirror 152 are disposed on the both surfaces of the transparent substrate 50, respectively.

The optical element 122 in the present embodiment includes a first area 150A and a second area 150B.

In the optical element 122 in the present embodiment, the first area 150A is disposed so as to correspond to at least an area in which the first dichroic mirror 151 is formed out of the transparent substrate 50.

The second area 150B is disposed so as to correspond to an area in which only the second dichroic mirror 152 is formed out of the transparent substrate 50. The first area 150A is disposed at the center of the optical element 122, and the second area 150B is disposed so as to surround the periphery of the first area 150A.

The first dichroic mirror 151 has a characteristic of reflecting the light in the blue wavelength band while transmitting the light in the red wavelength band. The second dichroic mirror 152 has a characteristic of transmitting the light in the red wavelength band and the light in the blue wavelength band while reflecting the light in the green wavelength band.

In the optical element 122 in the present embodiment, the first blue light BL1 as a part of the light flux of the blue light BL enters the first area 150A, and the second blue light BL2 as the rest of the light flux of the blue light BL enters the second area 150B.

As described hereinabove, the optical element 122 in the present embodiment reflects the first blue light BL1 which has entered the first area 150A toward the first wavelength conversion element 124, and at the same time, transmits the second blue light BL2 which has entered the second area 150B toward the second wavelength conversion element 126.

The first wavelength conversion element 124 is provided with the first base member 41, a first wavelength conversion layer 142, the first reflecting layer 43, and the first heatsink 44. The first wavelength conversion layer 142 includes a red phosphor which is excited by the first blue light BL1 in the blue wavelength band to emit the light in the red wavelength band. The first wavelength conversion layer 142 performs the wavelength conversion of the first blue light BL1 into the fluorescence (the second light) RL.

The red phosphor constituting the first wavelength conversion layer 142 in the present embodiment is formed of substantially the same red phosphor as that of the second wavelength conversion layer 47 in the first embodiment except the point that the red phosphor in the present embodiment includes a scattering element for scattering light inside. As the scattering element, there is used, for example, a plurality of air holes. Due to the configuration described above, a part of the first blue light BL1 having entered the first wavelength conversion element 124 is converted in wavelength by the first wavelength conversion layer 142 into the fluorescence RL. Meanwhile, another part of the first blue light BL1 is scattered by the scattering element before converted in wavelength into the fluorescence RL, and then emitted outside the first wavelength conversion element 124 as the diffused blue light BL3 without being converted in wavelength. On this occasion, the diffused blue light BL3 is emitted from the first wavelength conversion element 124 in a state of being diffused into an angular distribution substantially the same as the angular distribution of the fluorescence RL.

As described hereinabove, the first wavelength conversion element 124 in the present embodiment converts a part of the first blue light BL1 into the fluorescence RL as the red light, and diffuses another part of the first blue light BL1 to emit the result as the diffused blue light BL3. In other words, the first wavelength conversion element 124 emits light WL3 including the diffused blue light BL3 and the fluorescence RL toward the first pickup optical system 23. The light WL3 emitted from the first wavelength conversion element 124 is collimated by the first pickup optical system 23, and then enters the optical element 122. The light WL3 emitted from the first wavelength conversion element 124 enters the entire area of the optical element 122.

Specifically, the central component of the light WL3 enters the first area 150A where the first dichroic mirror 151 is disposed. The first dichroic mirror 151 has a characteristic of reflecting the light in the blue wavelength band while transmitting the light in the red wavelength band as described above. The fluorescence RL included in the light WL3 emitted from the first wavelength conversion element 124 is the red light, and is therefore transmitted through the first dichroic mirror 151 provided to the first area 150A.

The peripheral component of the light WL3 is transmitted through the transparent substrate 50 to enter the second dichroic mirror 152 provided to the second area 150B. As described above, the second dichroic mirror 152 has a characteristic of transmitting the light in the red wavelength band and the light in the blue wavelength band. Therefore, the fluorescence RL and the diffused blue light BL3 included in the light WL3 are transmitted through the optical element 122.

Therefore, the first area 150A emits the fluorescence RL out of the light WL3 emitted from the first wavelength conversion element 124, and the second area 150B emits the fluorescence RL and the diffused blue light BL3 out of the light WL3.

Meanwhile, the second blue light BL2 transmitted through the second area 150B of the optical element 122 enters the second wavelength conversion element 126 via the second pickup optical system 25. The second wavelength conversion element 126 is provided with the second base member 46, a second wavelength conversion layer 147, the second reflecting layer 48, and the second heatsink 49. In the present embodiment, the second wavelength conversion layer 147 includes a green phosphor which is excited by the second blue light BL2 in the blue wavelength band to emit the light in the green wavelength band. The second wavelength conversion layer 147 performs the wavelength conversion of the second blue light BL2 into the fluorescence (the third light) GL.

The phosphor constituting the second wavelength conversion layer 147 in the present embodiment is formed of substantially the same green phosphor as that of the first wavelength conversion layer 42 in the first embodiment except the point that the phosphor in the present embodiment does not include the scattering element for scattering light inside. It should be noted that the second wavelength conversion element 126 is made capable of performing the wavelength conversion of the whole of the second blue light BL2 having entered the second wavelength conversion layer 147 by, for example, appropriately setting the thickness of the second wavelength conversion layer 147.

The fluorescence GL emitted from the second wavelength conversion element 126 is collimated by the second pickup optical system 25, and then enters the entire area of the optical element 122. The fluorescence GL enters the first area 150A and the second area 150B. Specifically, the fluorescence GL enters the second dichroic mirror 152 provided to the second surface 50b of the transparent substrate 50.

As described above, since the second dichroic mirror 152 has a characteristic of reflecting the light in the green wavelength band, the optical element 122 reflects the fluorescence GL. The second dichroic mirror 152 is disposed in both of the first area 150A and the second area 150B. The first area 150A and the second area 150B emit the fluorescence GL emitted from the second wavelength conversion element 126. Therefore, in the optical element 122 in the present embodiment, the first area 150A and the second area 150B reflect the fluorescence GL, and transmit the fluorescence RL. Hereinafter, out of the fluorescence RL, a component emitted from the first area 150A is referred to as fluorescence RL1, and a component emitted from the second area 150B is referred to as fluorescence RL2.

Therefore, in the optical element 122 in the present embodiment, the first area 150A disposed at the center of the optical element 122 emits the yellow illumination light WL1 obtained by combining the fluorescence RL1 and the fluorescence GL1 with each other.

In contrast, the fluorescence RL and the diffused blue light BL3 included in the peripheral portion of the optical element 122 out of the light WL3 emitted from the first wavelength conversion element 124 are transmitted through the transparent substrate 50 and the second dichroic mirror 152. Further, the component having entered the peripheral portion of the optical element 122 out of the fluorescence GL emitted from the second wavelength conversion element 126 is reflected by the second dichroic mirror 152.

Therefore, the second area 150B disposed in the peripheral portion of the optical element 122 emits the white illumination light WL2 obtained by combining the fluorescence RL2, the fluorescence GL2, and the diffused blue light BL3 with each other.

As described hereinabove, according to the optical element 122 in the present embodiment, the yellow illumination light WL1 is emitted from the first area 150A toward the homogenization illumination optical system 30, and the white illumination light WL2 is emitted from the second area 150B toward the homogenization illumination optical system 30. It is possible for the optical element 122 in the present embodiment to emit the illumination light L including the yellow illumination light WL1 and the white illumination light WL2 toward the homogenization illumination optical system 30.

### Advantages of Second Embodiment

Also in the illumination device 12 according to the present embodiment, substantially the same advantages as those of the illumination device 2 according to the first embodiment can be obtained. Specifically, since the illumination device 12 is not required to compress the flux width of the blue light BL to enter the optical element 122, the flux compression device becomes unnecessary or can be reduced in size. Therefore, the device configuration of the illumination device 12 can be reduced in size.

It should be noted that in the optical element 122 in the present embodiment, it is possible to form the first dichroic mirror 151 and the second dichroic mirror 152 on the same surface (e.g., the first surface 50a) of the transparent substrate 50. In this case, as the first dichroic mirror 151, there is used a mirror having a characteristic of reflecting the light in the green wavelength band in addition to the light in the blue wavelength band, and transmitting the light in the red wavelength band.

### Third Embodiment

A third embodiment of the present disclosure will hereinafter be described using the drawings.

A projector according to the third embodiment is substantially the same in configuration as those of the other embodiments described above including the first embodiment, but is different in configuration of apart of the illumination device from those of the embodiments described above. Therefore, the description of the overall configuration of the projector and a common configuration of the illumination device will be omitted. It should be noted that members and constituents common to the embodiments described above will be denoted by the same reference symbols.

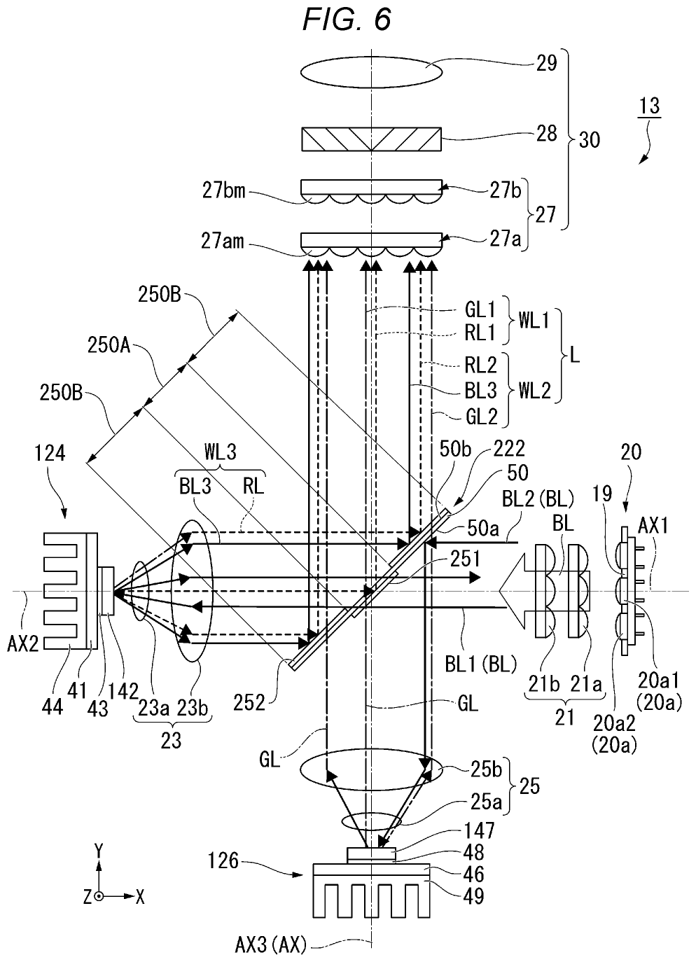

FIG. 6 is a schematic configuration diagram of an illumination device according to the third embodiment.

As shown in FIG. 6, the illumination device 13 according to the present embodiment is provided with the blue array light source 20, the homogenizer optical system 21, an optical element 222, the first pickup optical system 23, the first wavelength conversion element 124, the second pickup optical system 25, the second wavelength conversion element 126, and the homogenization illumination optical system 30.

In the illumination device 13 according to the present embodiment, the optical element 222 transmits the first blue light BL1 to enter the first wavelength conversion element 124, and reflects the second blue light BL2 to enter the second wavelength conversion element 126. In other words, the illumination device 13 according to the present embodiment has a layout in which the positions of the first wavelength conversion element 124 and the second wavelength conversion element 126 with respect to the blue array light source 20 and the optical element 122 in the illumination device 12 according to the second embodiment are reversed.

In the present embodiment, the blue array light source 20, the homogenizer optical system 21, the optical element 222, the first pickup optical system 23, and the first wavelength conversion element 124 are disposed on the optical axis AX1. The second wavelength conversion element 126, the second pickup optical system 25, the optical element 222, and the homogenization illumination optical system 30 are disposed on the illumination optical axis AX. In the present embodiment, the optical axis AX1 and the optical axis AX2 coincide with each other, and the illumination optical axis AX and the optical axis AX3 coincide with each other.

The optical element 222 in the present embodiment has the transparent substrate 50, a first dichroic mirror 251, and a second dichroic mirror 252. In the optical element 222 in the present embodiment, the first dichroic mirror 251 and the second dichroic mirror 252 are disposed on the both surfaces of the transparent substrate 50, respectively.

In the present embodiment, a planar shape of the first dichroic mirror 251 is a substantially circular shape. A planar shape of the second dichroic mirror 252 is a substantially ring-like shape.

The first dichroic mirror 251 has a characteristic of transmitting the light in the blue wavelength band, reflecting the light in the red wavelength band, and transmitting the light in the green wavelength band. The second dichroic mirror 252 has a characteristic of reflecting the light in the red wavelength band and the light in the blue wavelength band while transmitting the light in the green wavelength band.

The optical element 222 in the present embodiment includes a first area 250A and a second area 250B. In the optical element 222 in the present embodiment, the first area 250A is disposed so as to correspond to at least an area in which the first dichroic mirror 251 is formed out of the transparent substrate 50.

The second area 250B is disposed so as to correspond to an area in which the second dichroic mirror 252 is formed out of the transparent substrate 50. The first area 250A is disposed at the center of the optical element 222, and the second area 250B is disposed so as to surround the periphery of the first area 250A.

As described hereinabove, the optical element 222 in the present embodiment transmits the first blue light BL1 which has entered the first area 250A toward the first wavelength conversion element 124, and at the same time, reflects the second blue light BL2 which has entered the second area 250B toward the second wavelength conversion element 126.

In the present embodiment, the light WL3 emitted from the first wavelength conversion element 124 enters the entire area of the optical element 222. The central part of the light WL3 enters the first area 250A disposed in the central part of the optical element 222. The central part of the light WL3 is transmitted through the transparent substrate 50 and then enters the first dichroic mirror 251.

The first dichroic mirror 251 has a characteristic of transmitting the light in the blue wavelength band while reflecting the light in the red wavelength band as described above. Therefore, the fluorescence RL included in the light WL3 is reflected by the first dichroic mirror 251 provided to the first area 250A.

The peripheral component of the light WL3 enters the second dichroic mirror 252 provided to the second area 250B. As described above, the second dichroic mirror 252 has a characteristic of reflecting the light in the red wavelength band and the light in the blue wavelength band. Therefore, the fluorescence RL and the diffused blue light BL3 included in the light WL3 are reflected by the optical element 222.

Meanwhile, the second blue light BL2 reflected by the second area 250B of the optical element 222 enters the second wavelength conversion element 126 via the second pickup optical system 25. The fluorescence GL emitted from the second wavelength conversion element 126 enters the entire area of the optical element 222. The fluorescence GL enters the second dichroic mirror 252 provided to the second surface 50b of the transparent substrate 50. As described above, since the second dichroic mirror 252 has a characteristic of transmitting the light in the green wavelength band, the fluorescence GL is transmitted through the optical element 222. Therefore, in the optical element 222 in the present embodiment, the first area 250A and the second area 250B transmit the fluorescence GL, and reflect the fluorescence RL.

Therefore, the first area 250A disposed at the center of the optical element 222 emits the yellow illumination light WL1 obtained by combining the fluorescence RL1 and the fluorescence GL1 with each other.

In contrast, the fluorescence RL and the diffused blue light BL3 included in the peripheral portion of the optical element 222 out of the light WL3 emitted from the first wavelength conversion element 124 are reflected by the second dichroic mirror 252. Further, the component having entered the peripheral portion of the optical element 222 out of the fluorescence GL emitted from the second wavelength conversion element 126 is transmitted through the transparent substrate 50 and the second dichroic mirror 252.

Therefore, the second area 250B disposed in the peripheral portion of the optical element 222 emits the white illumination light WL2 obtained by combining the fluorescence RL2, the fluorescence GL2, and the diffused blue light BL3 with each other.

As described hereinabove, according to the optical element 222 in the present embodiment, the yellow illumination light WL1 is emitted from the first area 250A toward the homogenization illumination optical system 30, and the white illumination light WL2 is emitted from the second area 250B toward the homogenization illumination optical system 30. Therefore, it is possible for the optical element 222 in the present embodiment to emit the illumination light L including the yellow illumination light WL1 and the white illumination light WL2 toward the homogenization illumination optical system 30.

### Advantages of Third Embodiment

Also in the illumination device 13 according to the present embodiment, substantially the same advantages as those of the illumination device 12 according to the second embodiment can be obtained. Specifically, since in the illumination device 13, the flux compression device becomes unnecessary or can be reduced in size, it is possible to reduce the size of the illumination device 13 itself.

### Fourth Embodiment

A fourth embodiment of the present disclosure will hereinafter be described using the drawings.

A projector according to the fourth embodiment is substantially the same in configuration as those of the other embodiments described above including the first embodiment, but is different in configuration of apart of the illumination device from those of the embodiments described above. Therefore, the description of the overall configuration of the projector and a common configuration of the illumination device will be omitted. It should be noted that members and constituents common to the embodiments described above will be denoted by the same reference symbols.

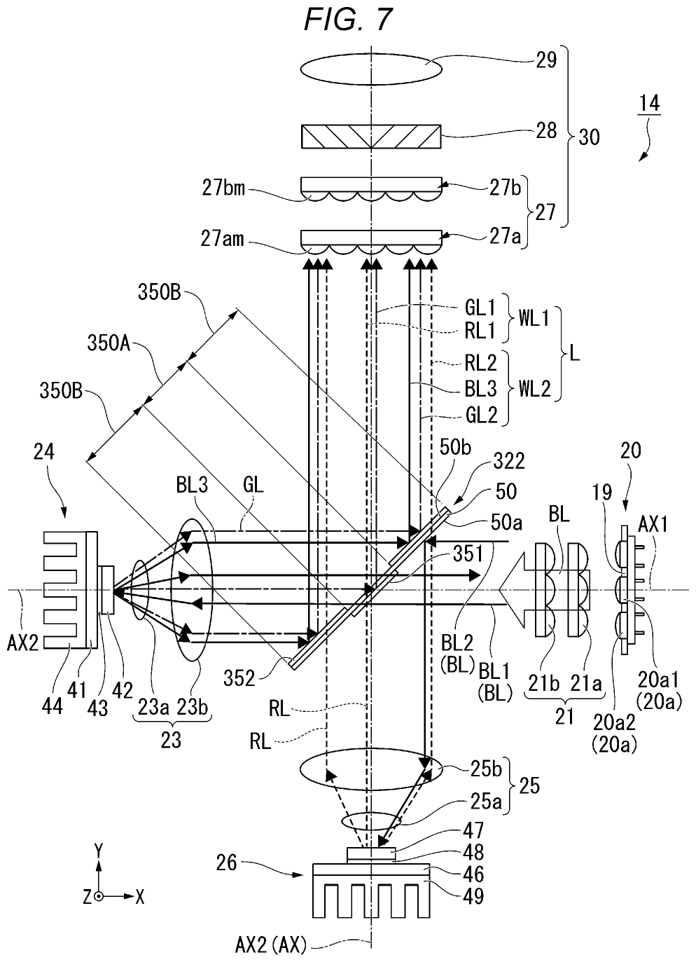

FIG. 7 is a schematic configuration diagram of an illumination device according to the fourth embodiment.

As shown in FIG. 7, the illumination device 14 according to the present embodiment is provided with the blue array light source 20, the homogenizer optical system 21, an optical element 322, the first pickup optical system 23, the first wavelength conversion element 24, the second pickup optical system 25, the second wavelength conversion element 26, and the homogenization illumination optical system 30.

In the illumination device 14 according to the present embodiment, the optical element 322 transmits the first blue light BL1 to enter the first wavelength conversion element 24, and reflects the second blue light BL2 to enter the second wavelength conversion element 26. In other words, the illumination device 14 according to the present embodiment has a layout in which the positions of the first wavelength conversion element 24 and the second wavelength conversion element 26 with respect to the blue array light source 20 and the optical element 22 in the illumination device 2 according to the first embodiment are reversed.

In the present embodiment, the blue array light source 20, the homogenizer optical system 21, the optical element 322, the first pickup optical system 23, and the first wavelength conversion element 24 are disposed on the optical axis AX1. The second wavelength conversion element 26, the second pickup optical system 25, the optical element 322, and the homogenization illumination optical system 30 are disposed on the illumination optical axis AX.

The optical element 322 in the present embodiment has the transparent substrate 50, a first dichroic mirror 351, and a second dichroic mirror 352. In the optical element 322 in the present embodiment, the first dichroic mirror 351 and the second dichroic mirror 352 are disposed on the both surfaces of the transparent substrate 50, respectively.

In the present embodiment, a planar shape of the first dichroic mirror 351 is a substantially circular shape. A planar shape of the second dichroic mirror 352 is a substantially ring-like shape.

The first dichroic mirror 351 has a characteristic of transmitting the light in the blue wavelength band and the light in the red wavelength band while reflecting the light in the green wavelength band. The second dichroic mirror 352 has a characteristic of transmitting the light in the red wavelength band while reflecting the light in the green wavelength band and the light in the blue wavelength band.

The optical element 322 in the present embodiment includes a first area 350A and a second area 350B. In the optical element 322 in the present embodiment, the first area 350A is disposed so as to correspond to at least the area where the first dichroic mirror 351 is formed out of the transparent substrate 50, and the second area 350B is disposed so as to correspond to the area where the second dichroic mirror 352 having the ring-like shape is formed out of the transparent substrate 50. The first area 350A is disposed at the center of the optical element 322, and the second area 350B is disposed so as to surround the periphery of the first area 350A.

As described hereinabove, the optical element 322 in the present embodiment transmits the first blue light BL1 which has entered the first area 350A toward the first wavelength conversion element 24, and at the same time, reflects the second blue light BL2 which has entered the second area 350B toward the second wavelength conversion element 26.

In the present embodiment, a central part of light WL emitted from the first wavelength conversion element 24 enters the first area 350A. The fluorescence GL included in the light WL is reflected by the first dichroic mirror 351 provided to the first area 350A.

A peripheral portion of the light WL enters the second dichroic mirror 352 provided to the second area 350B. The second dichroic mirror 352 reflects the fluorescence GL and the diffused blue light BL3 included in the light WL.

Meanwhile, the second blue light BL2 reflected by the second area 350B of the optical element 322 enters the second wavelength conversion element 26 to generate the fluorescence RL. In the optical element 322 in the present embodiment, the first area 350A and the second area 350B transmit the fluorescence RL, and reflect the fluorescence GL.

Therefore, the first area 350A disposed at the center of the optical element 322 emits the yellow illumination light WL1 obtained by combining the fluorescence RL1 and the fluorescence GL1 with each other.

In contrast, the fluorescence GL and the diffused blue light BL3 included in the peripheral portion of the optical element 322 out of the light WL emitted from the first wavelength conversion element 24 are reflected by the second dichroic mirror 352. Further, the component having entered the peripheral portion of the optical element 322 out of the fluorescence RL is transmitted through the transparent substrate 50 and the second dichroic mirror 352.

Therefore, the second area 350B disposed in the peripheral portion of the optical element 322 emits the white illumination light WL2 obtained by combining the fluorescence RL2, the fluorescence GL2, and the diffused blue light BL3 with each other.

As described hereinabove, according to the optical element 322 in the present embodiment, the yellow illumination light WL1 is emitted from the first area 350A toward the homogenization illumination optical system 30, and the white illumination light WL2 is emitted from the second area 350B toward the homogenization illumination optical system 30. Therefore, it is possible for the optical element 322 in the present embodiment to emit the illumination light L including the yellow illumination light WL1 and the white illumination light WL2 toward the homogenization illumination optical system 30.

### Advantages of Fourth Embodiment

Also in the illumination device 14 according to the present embodiment, substantially the same advantages as those of the illumination device 2 according to the first embodiment can be obtained. Specifically, since in the illumination device 14, the flux compression device becomes unnecessary or can be reduced in size, it is possible to reduce the size of the illumination device 14 itself.

### FIRST MODIFIED EXAMPLE

Another aspect of the first wavelength conversion element 24 will hereinafter be described as a first modified example of the present disclosure using the drawings. It should be noted that members common to the embodiment described above will be denoted by the same reference symbols, and the detailed description thereof will be omitted.

In the embodiment described above, there is cited when using the air holes included in the first wavelength conversion layer 42 as the diffusion device for diffusely reflecting a part of the blue light BL as an example, the diffusion device is not limited to the air holes.

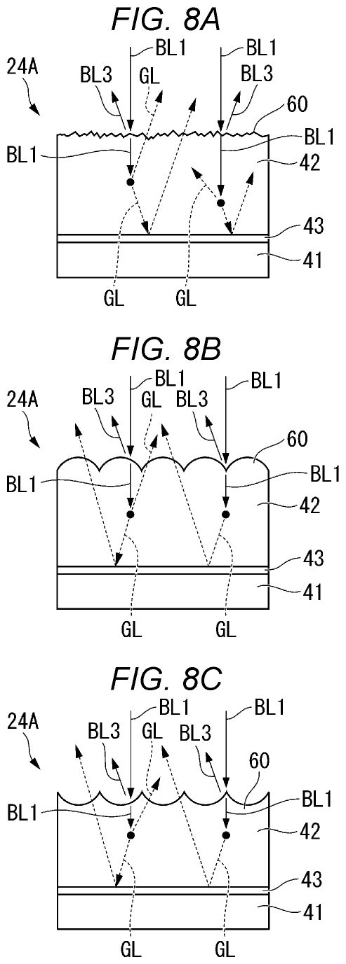

FIG. 8A through FIG. 8C are diagrams each showing a configuration of a principal part of the first wavelength conversion element 24A in the first modified example.

As shown in FIG. 8A through FIG. 8C, the first wavelength conversion element 24A in the present modified example is provided with the first base member 41, the first wavelength conversion layer 42, the first reflecting layer 43, the first heatsink 44, and a reflecting part 60.

The reflecting part 60 is formed of a diffusely reflecting surface provided to a plane of incidence of light of the first wavelength conversion layer 42. The diffusely reflecting surface has a function of diffusely reflecting a part of the first blue light BL1 toward the first pickup optical system 23 as the diffused blue light BL3.

Specifically, the diffusely reflecting surface can be formed by performing a texture treatment on the plane of incidence of light of the first wavelength conversion layer 42 as shown in, for example, FIG. 8A. In this case, it is possible for the reflecting part 60 to diffusely reflect a part of the first blue light BL1 as the diffused blue light BL3 using backscattering due to a roughened surface.

Further, the diffusely reflecting surface can be formed by performing a dimple treatment on the plane of incidence of light of the first wavelength conversion layer 42 as shown in, for example, FIG. 8B. In this case, it is possible for the reflecting part 60 to diffusely reflect a part of the first blue light BL1 as the diffused blue light BL3 using Fresnel reflection due to a surface provided with a number of convex surfaces.

Further, the diffusely reflecting surface is not limited to one provided with the number of convex surfaces with the dimple treatment, and can also be one provided with a number of concave surfaces with the dimple treatment as shown in, for example, FIG. 8C, or a concave-convex surface provided with a number of convex surfaces and concave surfaces (not shown) with the dimple treatment.

It should be noted that it is possible to dispose a reflection enhancing film not shown on the diffusely reflecting surface. In this case, it is possible to increase the proportion of the first blue light BL1 reflected by the reflecting part 60. Further, it is also possible to use the diffusely reflecting surface as the diffusing device of the first wavelength conversion layer 142 of the first wavelength conversion element 124.

### Advantages of First Modified Example

According to the first wavelength conversion element 24A in the present modified example, since there is provided the reflecting part 60 formed of the diffusely reflecting surface provided to the plane of incidence of light of the first wavelength conversion layer 42, it is possible to perform the backscattering on a part of the first blue light BL1 entering the first wavelength conversion element 24A to emit the diffused blue light BL3 in the state of being diffused into the angular distribution substantially the same as the angular distribution of the fluorescence GL.

### SECOND MODIFIED EXAMPLE

Another aspect of the first wavelength conversion element 24 will hereinafter be described as a second modified example of the present disclosure using the drawing. It should be noted that members common to the embodiment described above will be denoted by the same reference symbols, and the detailed description thereof will be omitted.

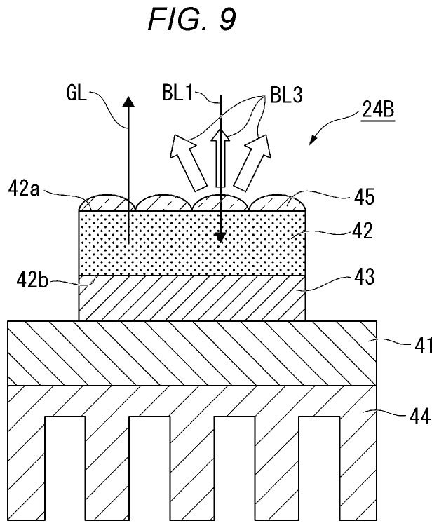

FIG. 9 is a cross-sectional view of a wavelength conversion element in the second modified example.

As shown in FIG. 9, the first wavelength conversion element 24B in the present modified example is provided with the first base member 41, the first wavelength conversion layer (a wavelength conversion layer) 42, the first reflecting layer (a reflecting layer) 43, the first heatsink 44, and a structure 45.

The structure 45 is disposed on the first surface 42a as a plane of incidence of light of the first wavelength conversion layer 42. The structure 45 scatters a part of the first blue light BL1 which enters the first wavelength conversion element 24B, and then reflects the result toward an opposite direction to the incident direction of the first blue light BL1. The structure 45 is formed of a light transmissive material, and has a plurality of scattering structures. The scattering structures in the present embodiment each have a lens shape formed of a protruding part.

The structure 45 is formed separately from the first wavelength conversion layer 42. A method of forming a dielectric body using, for example, an evaporation process, a sputtering process, a CVD process, or a coating process, and then processing the dielectric body using photolithography is suitable for the structure 45 in the present embodiment. It is desirable for the structure 45 to be formed of a material which is low in light absorption and is chemically stable. The structure 45 is formed of a material having a refractive index in a range of 1.3 through 2.5, and there can be used, for example, SiO₂, SiON, or TiO₂. For example, when forming the structure 45 using SiO₂, it is possible to accurately process the structure 45 using wet etching or dry etching.

Due to the configuration described above, a part of the first blue light BL1 having entered the first wavelength conversion element 24B is transmitted through the structure 45, and is then converted in wavelength by the first wavelength conversion layer 42 into the fluorescence GL. Meanwhile, another part of the first blue light BL1 is scattered backward by the structure 45 before converted in wavelength into the fluorescence GL, and then emitted outside the first wavelength conversion element 24B as the diffused blue light BL3 without being converted in wavelength. On this occasion, the diffused blue light BL3 is emitted from the structure 45 in a state of being diffused into an angular distribution substantially the same as the angular distribution of the fluorescence GL.

It should be noted that it is also possible to use the structure 45 described above as the diffusing device of the first wavelength conversion layer 142 of the first wavelength conversion element 124.

### Advantages of Second Modified Example

The first wavelength conversion element 24B in the present modified example has the first wavelength conversion layer 42 for converting the blue light BL into the fluorescence GL, the structure 45 which is disposed on the first surface 42a of the first wavelength conversion layer 42, and which diffusely reflects another part of the blue light BL, and the first reflecting layer 43 disposed on the second surface 42b of the first wavelength conversion layer 42.

According to the first wavelength conversion element 24B in the present modified example, since there is provided the structure 45, it is possible to perform the backscattering on a part of the blue light BL entering the first wavelength conversion element 24B to emit the blue light BL in the state of being diffused into the angular distribution substantially the same as the angular distribution of the fluorescence GL.

It should be noted that the scope of the present disclosure is not limited to the embodiments described above, but a variety of modifications can be provided thereto within the scope or the spirit of the present disclosure.

For example, the stationary structure in which the wavelength conversion layers do not move with respect to the blue light BL is adopted in the first wavelength conversion element and the second wavelength conversion element in the embodiments described above, but it is possible to adopt a wheel type structure in which the wavelength conversion layers rotate with respect to the blue light BL.

Besides the above, the specific descriptions of the shape, the number, the arrangement, the material, and so on of the constituents of the illumination device and the projector are not limited to those in the embodiments described above, but can arbitrarily be modified. Although in each of the embodiments, there is described the example of installing the illumination device according to the present disclosure in the projector using the liquid crystal light valves, the example is not a limitation. The illumination device according to the present disclosure can also be applied to a projector using digital micromirror devices as the light modulation devices. Further, the projector is not required to have a plurality of light modulation devices, and can be provided with just one light modulation device.

Although in each of the embodiments described above, there is described the example of applying the illumination device according to the present disclosure to the projector, the example is not a limitation. The illumination device according to the present disclosure can also be applied to lighting equipment, a headlight of a vehicle, and so on.

It is also possible for an illumination device according to an aspect of the present disclosure to have the following configuration.

The illumination device according to an aspect of the present disclosure includes a light source section configured to emit first light in a first wavelength band, an optical element having a first area configured to one of transmit and reflect a part of the first light, and a second area configured to one of reflect another part of the first light when the first light is transmitted through the first area and transmit another part of the first light when the first light is reflected by the first area, a first wavelength conversion element which the first light emitted from the first area of the optical element enters, which is configured to convert a part of the first light into second light in a second wavelength band different from the first wavelength band while diffusing another part of the first light, and then emit a result, and a second wavelength conversion element which the first light emitted from the second area of the optical element enters, and which is configured to convert the first light into third light in a third wavelength band different from the first wavelength band and the second wavelength band, wherein the first area and the second area reflect the third light when transmitting the second light, and transmit the third light when reflecting the second light, and the second area is disposed so as to surround a periphery of the first area.

In the illumination device according to the aspect of the present disclosure, there may be adopted a configuration in which the first wavelength conversion element includes a wavelength conversion layer configured to convert the first light into second light, a reflecting layer provided to a first surface of the wavelength conversion layer, and a structure provided to a second surface of the wavelength conversion layer.

In the illumination device according to the aspect of the present disclosure, there may be adopted a configuration in which there is further included a homogenization illumination optical system configured to homogenize an illuminance distribution of light emitted from the optical element, wherein the first area of the optical element emits first illumination light including light in the second wavelength band and light in the third wavelength band toward the homogenization illumination optical system, and the second area of the optical element emits second illumination light including light in the first wavelength band, light in the second wavelength band, and light in the third wavelength band toward the homogenization illumination optical system.

A projector according to still another aspect of the present disclosure may have the following configuration.

The projector according to still another aspect of the present disclosure includes the illumination device according to the first aspect of the present disclosure, alight modulation device configured to modulate light from the illumination device in accordance with image information, and a projection optical device configured to project the light modulated by the light modulation device.

What is claimed is:

1. An illumination device comprising:
a light source section configured to emit first light in a first wavelength band;
an optical element having a first area configured to one of transmit and reflect a part of the first light, and a second area configured to one of reflect another part of the first light when the first light is transmitted through the first area and transmit another part of the first light when the first light is reflected by the first area;
a first wavelength conversion element which the first light emitted from the first area of the optical element enters, which is configured to convert a part of the first light into second light in a second wavelength band different from the first wavelength band while diffusing another part of the first light, and then emit a result; and
a second wavelength conversion element which the first light emitted from the second area of the optical element enters, and which is configured to convert the first light into third light in a third wavelength band different from the first wavelength band and the second wavelength band, wherein
the first area and the second area reflect the third light when transmitting the second light, and transmit the third light when reflecting the second light, and
the second area is disposed so as to surround a periphery of the first area.

2. The illumination device according to claim 1, wherein
the first wavelength conversion element includes
a wavelength conversion layer configured to convert the first light into the second light,
a reflecting layer provided to a first surface of the wavelength conversion layer, and
a structure provided to a second surface of the wavelength conversion layer.

3. The illumination device according to claim 1, further comprising:
a homogenization illumination optical system configured to homogenize an illuminance distribution of light emitted from the optical element, wherein
the first area of the optical element emits first illumination light including light in the second wavelength band and light in the third wavelength band toward the homogenization illumination optical system, and
the second area of the optical element emits second illumination light including light in the first wavelength band, light in the second wavelength band, and light in the third wavelength band toward the homogenization illumination optical system.

4. A projector comprising:
the illumination device according to claim 1;
a light modulation device configured to modulate light
from the illumination device in accordance with image information; and
a projection optical device configured to project the light modulated by the light modulation device.
